(19) United States
(12) Patent Application Publication
(10) Pub. No.: US 2007/0219763 A1
(43) Pub. Date: Sep. 20, 2007

(54) Methods of and apparatus for analysing a signal

(76) Inventors: John Alec Sydney Smith, London (GB); Stephen Nicholas Mallion, Knutsford (GB); David John Malcolme-Lawes, Essex (GB); Michael David Rowe, London (GB)

Correspondence Address: NIXON & VANDERHYE, PC, 901 NORTH GLEBE ROAD, 11TH FLOOR, ARLINGTON, VA, 22203, US

(21) Appl. No.: 11/599,592

(22) Filed: Nov. 15, 2006

Related U.S. Application Data
(63) Continuation of application No. 10/036,479, filed on Jan. 7, 2002, now abandoned.

(30) Foreign Application Priority Data
Jul. 6, 1999 (GB) GB9915842.0
Jul. 5, 2000 (GB) PCT/GB00/02582

(51) Int. Cl. G06F 7/60

(52) U.S. Cl. 703/2

(57) ABSTRACT

A method of and apparatus for analysing a signal is disclosed, the method comprising producing a model of the signal and comparing the model to a predetermined model of a signal due to a phenomenon, thereby to determine whether the model represents a signal due to that phenomenon. A method of and apparatus for detecting the presence of a sample in a larger sample which is not known to contain the sample is also disclosed, the method comprising detecting a signal comprising a response from the sample, producing a model of the signal, and comparing the model to a predetermined model of a response from the sample, thereby to determine whether the sample is present. The techniques have particular application in Magnetic Resonance and Quadrupole Resonance.

The invention relates to a method of and apparatus for analysing a signal and to a method of and apparatus for detecting the presence of a sample. The signal may comprise a response from a sample, or an undesired signal, or a response from a sample together with an undesired signal. The response may be due to, for example, the excitation of electrons or nuclei within the sample. The invention has particular application in techniques such as Magnetic Resonance (MR), Quadrupole Resonance (QR) and Electron Spin Resonance (EQR), although it is equally applicable to other fields where a signal is analysed.

One particular use of the techniques described herein is in the detection of the presence of substances, such as explosives or narcotics, by applying excitation and detecting a response. The detection may be of baggage at airports, or of explosives or drugs concealed on the person or buried underground or elsewhere. The detector may be mounted next to a conveyor belt, or on a walk-through gateway, or on a hand-held wand.

In order to analyse response signals, they are usually transformed into the frequency domain by Fourier transformation, and the resulting frequency spectrum then examined. Such techniques are exemplified by International Patent Application No. WO 92/21989 in the name of British Technology Group Limited, the subject matter of which is incorporated herein by reference. In that disclosure, the signal comprises a response from a sample due to the excitation of particular nuclei in the sample, and the presence of the sample is detected by transforming the response into the frequency domain and determining whether the signal is above a certain threshold at the frequencies of the excited nuclei.

In practical situations, such as the detection of buried explosives or airport security monitoring, undesired signals may be present which may interfere with or obscure the true response signal. By undesired signal is meant any unwanted signal, such as noise or interference, which may originate from an external interference source, or from the sample, or from the testing apparatus itself. The undesired signal may be larger than the response signal, which may make the response signals impossible to distinguish on the basis of signal height alone.

One type of undesired signal is interference due to external sources producing rf spikes at random points in time, which may cause corruption of the response signal. Interference may also come from more stable sources of rf energy at a single frequency, such as amplitude modulation (am) or frequency modulation (fin) radio transmissions. This type of interference may produce a line that could be confused with, or obscure, the response signal.

Another type of undesired signal is spurious response signals (also termed spurious interference) which may be generated by objects or matter surrounding or in the vicinity of the substance to be detected. Such spurious response signals may occur in particular when techniques such as Quadrupole Resonance are used. Examples of such spurious response signals are the piezo-electric signal generated in quartz, dry sand or soil by the electric field of the rf pulse, or the magneto-acoustic signal generated, for example, by ferromagnetic objects in response to the rf pulse. The spurious response signals may be large enough to obscure or obliterate the response signal.

In addition to the undesired signals described above, random noise signals may also be present.

The problem of undesired signals may be overcome by using multiple pulse sequences to improve the signal to noise ratio (SNR). However, in practical situations where there is relative movement between the detector and the sample, the sample may only be exposed to the detector for a limited period of time, so that limited time is available in which to perform the detection. In such situations, multiple pulse sequences would have to be truncated in order to reduce the test time. The Fourier Transformation of such sequences would yield distorted spectra, which may reduce the effectiveness of the test.

The present invention seeks to improve the analysis of response signals, in particular, but not exclusively, in situations where undesired signals may be present and/or where the time taken to perform the test is limited.

In a first aspect of the present invention there is provided a method of analysing a signal comprising producing a model of the signal and comparing the model to a predetermined model of a signal due to a phenomenon, thereby to determine whether the model represents a signal due to that phenomenon.

In a further aspect of the present invention there is provided a method of analysing a signal obtained by applying excitation to a sample and detecting a resonance response, comprising producing a model of the signal and comparing the model to a predetermined model of a signal due to a phenomenon, thereby to determine whether the model represents a signal due to that phenomenon.

The model may suitably be such as to effect a change to the form of the signal. It may be a statistical model.

The present invention may provide the advantage of determining, with a greater degree of accuracy than hitherto, whether or not a signal is due, at least in part, to a particular phenomenon.

The present invention takes a different approach to the analysis of signals than the Fourier Transformation technique outlined above, in that, rather than analysing the signal directly, a model of the signal is produced, and this model is analysed.

For example, the predetermined model may be a predetermined model of a response from a sample, and the comparing step may be to determine whether the model represents a response from the sample. The model is a simplified representation of the signal, and thus may or may not represent a response from the sample, depending, for example, on the number of components of the model, and the relative intensity of any undesired signals. By comparing the model with a predetermined model of a response from a sample it may be determined whether the model does represent a response from the sample. In this way a true response signal may be distinguished from an undesired signal.

In certain circumstances it may be desirable to determine whether or not an undesired signal is present so that appropriate action may be taken. Thus, the predetermined model may be a predetermined model of an undesired signal and the comparing step may be to determine whether the model represents such an undesired signal. The undesired signal may comprise at least one of an interference signal, a noise signal, and a spurious response signal (such as a magneto-acoustic response signal or a piezo-electric response signal) from a sample.

The signal may comprise a response from a sample and an undesired signal (for example, an interference signal, a spurious response signal, or a noise signal), and the comparing step may be to distinguish the response from the undesired signal. In that case, in the producing step, the model preferably models the response and the undesired signal. Thus it will be appreciated that the model may be determined to represent a signal due to a phenomenon as long as at least a component of the model represents a signal due to the phenomenon. Preferably, the model comprises sufficient components to model both the response and the undesired signal so that the model will model the response even in the presence of undesired signals.

In a preferred embodiment, the model is first compared to a predetermined model of a response from a sample, in order to determine whether the model represents a response from the sample. If the model is not determined to represent a response from a sample, then it may be that an undesired signal is obscuring the response from the sample. In that case it may be desirable to know whether such an undesired signal is present, in order that the appropriate action is taken. Thus the method may comprise the steps of comparing the model to a predetermined model of a response from a sample, and comparing the model to a predetermined model of an undesired signal. It will be appreciated that the steps could be carried out in either order.

In many situations where a response from a sample is to be detected, it will not be known in advance whether and to what extent any undesired signals will be present. One approach to such a situation would be to assume that a large number of undesired signals are present, and then to produce a model with the largest possible number of components. However it has been discovered pursuant to the present invention that, particularly at low SNR, the best results are not necessarily obtained with the maximum number of components. Thus, in a preferred embodiment of the invention, the producing step and the comparing step are carried out with models having different numbers of components. This can allow the various steps to be carried out a plurality of times making different assumptions about the characteristics of the signal.

Preferably, if the model is determined to represent a signal due to the phenomenon, then the repetition stops, whereas if it is not so determined then the repetition continues, for example, to take account of the situation where the model only represents undesired signals. Thus the producing step and the comparing step may be repeated until the model is determined to represent a signal due to the phenomenon or until a given number of repetitions have been completed.

In one example, the producing step and the comparing step are carried out with models having increasing numbers of components. For example, it might first be assumed that there are no undesired signals, and the model might then initially comprise a single component, or else a number of components equal to the expected number of true response signals. If this assumption turns out to be incorrect, because the model does not represent a response from the sample (and thus the model may be presumed to represent undesired signals), then the number of components in the model may be increased. At each stage the number of components in the model may be increased by one, or by some other number. For example, the number of components could initially be increased by a relatively large number with each iteration, and then by a relatively small number. Decreasing values of M could also be used. Furthermore, the initial number of components of the model may be greater than the expected number of true response signals, for example where it is anticipated that undesired signals will be present.

The signal may be a time dependent signal and the model may comprise a time domain representation of the signal.

In order to fit the model to the signal, preferably, in the producing step the model comprises a component and a value of a parameter of the component is determined, such that the model fits the signal. In the simplest case, the model comprises a single component having a single parameter whose value is determined, although typically the model will comprise a plurality of components each having a plurality of parameters whose values are determined.

In order to determine whether the model represents a response from the sample, the comparing step may comprise comparing the thus determined value of the parameter to a predetermined value of the parameter.

Preferably, a component is determined to represent a response from the sample if the value of the parameter of that component is within a given range of the predetermined value of the parameter. The given range may be set beforehand, for example in accordance with the desired sensitivity of the test and/or acceptable success rate. Preferably, the predetermined value of the parameter is a value that the parameter would be expected to take if the component represented a signal due to the phenomenon.

The method may further comprise storing the predetermined value of the component, so that the value will be available when the analysis is carried out.

The method may further comprise determining the predetermined value of the parameter.

In one embodiment, in the comparing step it is determined whether the model represents a signal due to the phenomenon in dependence upon the number of components which are determined to represent a signal due to the phenomenon. For example, where signal is expected to comprise a response from a sample having a number of distinct responses, or a response with a particular structure or shape, the model may only be determined to represent a response from the sample if a certain number of those responses and/or their structure or shape are determined to be present. By shape it is meant a particular envelope on the FID, or the shape of the signal in the frequency domain. By this arrangement, the accuracy with which it may be determined that the model represents a signal due to the phenomenon may be improved. This embodiment is analogous to the “signature detection” technique described in WO 92/21989 cited above (see, for example, page 15 line 15 to page 18 line 15 of that document).

In order to improve the accuracy of the modelling, the or each component may have a plurality of parameters to be determined, and thus the producing step may comprise determining values of a plurality of parameters of a component, and the comparing step may comprise comparing the thus determined values of the parameters to predetermined values of the parameters.

Preferably a parameter is selected from at least one of frequency, amplitude, phase and damping factor. For example, MR and QR response signals have characteristic frequencies and thus frequency may be used to determine whether the model represents a response from a sample. Furthermore, it has been discovered pursuant to the present invention that both phase and damping factor may be used to help distinguish between different types of signals. In the case of phase, this is because the phase characteristics of typical responses from a sample may be different from the phase characteristics of undesired signals, even if the undesired signals are at the same frequency as the response. In the case of damping factor, the damping factor of true response signals is usually positive whereas interference and noise signals may have a negative damping factor. Where there is a plurality of parameters whose values are determined, then each of the parameters may be one of the above.

Naturally occurring response signals can often be modelled by decaying sinusoids, and thus a component of the model may be a decaying sinusoid.

It has been discovered pursuant to the present invention that under certain conditions, if the signal is inverted and a model of the inverted signal is produced, for response signals from a sample the sign of the damping factor may change in comparison to that of the original model, whereas for noise signals the sign of the damping factor may be unchanged. This may provide an additional technique for distinguishing response signals from noise signals. Thus the method may further comprise inverting the signal and producing a model of the inverted signal. The method may then further comprise comparing a sign of the damping factor of the model to a sign of the damping factor of the model of the inverted signal.

Preferably, the producing step is carried out using a statistical time domain technique. The statistical time domain technique may be of a type which does not involve a transformation of the response into the frequency domain. For example, the statistical time domain technique may be a Linear Prediction method, or a Matrix Pencil method, although other appropriate statistical time domain techniques into which prior information can be incorporated, such as Bayesian analysis or Maximum Likelihood, could be used.

The term “statistical time domain technique” as used herein is to be interpreted broadly as including any statistical technique which operates on data collected in the time domain. Such data could be of a signal. The term “statistical” is also to be interpreted broadly, as including any technique which effects a reduction in the amount of data. For example, if the signal is digitised in a given number of data points, the statistical model may have a smaller number of data points. The statistical technique may be descriptive rather than predictive.

Preferably, the response signal is of the type that results from excitation of a sample, and thus the method may be a method of testing a sample and may further comprise applying excitation to the sample and detecting the response to yield the signal. This important feature is provided independently.

A further aspect of the invention provides a method of analysing a signal to test a sample, the method comprising detecting a signal comprising a resonance response from the sample, producing a model of the signal, and comparing the model to a predetermined model of a signal due to a phenomenon, thereby to determine whether the model represents a signal due to that phenomenon. Preferably, the method further comprises applying excitation to excite the resonance response.

The type of response that is expected may depend on the particular conditions of the test, and thus the predetermined model may be selected in dependence on the test conditions, for example, on the type of excitation that is applied. For example, it has been discovered pursuant to the present invention that, in the field of QR, the expected parameter values may vary in dependence on the excitation pulse sequence, and/or whether FIDs or echoes are detected. Thus, the predetermined model may be selected in dependence on the type of pulse sequence that is applied, and/or whether FIDs or echoes are detected.

Where undesired signals are present, it may be desirable to identify the type of undesired signal that is present (for example, noise, interference, magneto-acoustic spurious response or piezo-electric spurious response), so that the experiment can be repeated under different test conditions to reduce the effect of that particular undesired signal. Thus the model may be compared to a predetermined model of an undesired signal, and the method may further comprise applying further excitation in dependence on the result of the comparison. Preferably the further excitation is such as to reduce the effect of the undesired signal; for example, excitation may be applied at a different frequency or an interference cancelling excitation probe may be used. If the undesired signal is time dependent (for example a random noise peak) it may be sufficient simply to repeat the test.

The excitation may be arranged to excite electrons or a given species of nucleus in the sample. For example, the excitation may be arranged to excite magnetic resonance, or to excite quadrupole resonance.

In one preferred embodiment the method is a method of detecting the presence of a sample in a larger sample which is not known to contain the sample.

Thus, the invention may also provide a method of detecting the presence of a sample in a larger sample which is not known to contain the sample, comprising:
detecting a signal comprising a (preferably resonance) response from the sample;
producing a model of the signal; and
comparing the model to a predetermined model of a response from the sample, thereby to determine whether the sample is present.

The detecting method may further comprise providing an alarm signal if the sample is determined to be present, to alert the operator to the presence of the substance.

In order to reduce any spurious interference, the excitation applying means is preferably adapted to apply phase cycled pulse sequences, preferably according to the doctrine of phase equivalence as taught in International Patent Application Number WO 96/26453 in the name of British Technology Group Limited, the subject matter of which is incorporated herein by reference.

Hence the method may be a method of quadrupole resonance testing a sample containing quadrupolar nuclei, which sample may give rise to spurious signals which interfere with response signals from the quadrupolar nuclei, the method further comprising:
applying a pulse sequence to the sample to excite quadrupole resonance, the pulse sequence comprising at least one pair of pulses;
detecting response signals; and
comparing, for the or each such pair, respective response signals following the two member pulses of the pair;
the pulse sequence being such that respective spurious signals following the two member pulses can be at least partially cancelled by the comparison without corresponding true quadrupole resonance signals being completely cancelled.

For the or each such pair, the two member pulses may be of like phase. For the or each such pair of pulses, a respective pulse preceding each member pulse of the pair may be of differing phase. The or each such pair of pulses may be of a first type, and the pulse sequence may further comprise at least one further second type pair of pulses, corresponding to the or each first type pair, but having cycled phases.

In an apparatus aspect of the present invention there is provided apparatus for analysing a signal comprising producing means (such as a suitably programmed processor) for producing a model of the signal, storing means (such as a store) for storing a predetermined model of a signal due to a phenomenon, and comparing means (such as a comparator, which may be a processor, for example, the same processor as the producing means) for comparing the model to the predetermined model to determine whether the model represents a signal due to that phenomenon.

In a further apparatus aspect of the present invention there is provided apparatus for analysing a signal obtained by applying excitation to a sample and detecting a resonance response, comprising producing means (such as a suitably programmed processor) for producing a model of the signal, storing means (such as a store) for storing a predetermined model of a signal due to a phenomenon, and comparing means (such as a comparator, which may be a processor, for example, the same processor as the producing means) for comparing the model to the predetermined model to determine whether the model represents a signal due to that phenomenon.

The predetermined model may be a predetermined model of a response from a sample, or a predetermined model of an undesired signal, in which case the undesired signal may comprise at least one of an interference signal, a noise signal, and a spurious response signal from a sample.

The signal may comprise a response from a sample and an undesired signal and the model preferably comprises sufficient components to model both the response and the undesired signal. For example, the model may comprise at least 2, 3, 5, or 10 components.

The comparing means may be adapted to compare the model to a predetermined model of a response from a sample and to a predetermined model of an undesired signal.

The apparatus may be adapted to produce models of the signal, and to compare the models to a predetermined model, with models having different numbers of components, which may depend on the pulse sequence being used and the type of signal being detected (such as an FID or an echo).

The apparatus may be adapted to produce models of the signal, and to compare the models to a predetermined model, until the model is determined to represent a signal due to the phenomenon or until a given number of repetitions have been completed.

The apparatus may be adapted to produce models of the signal, and to compare the models to a predetermined model, with models having increasing numbers of components.

The model may comprise a time domain representation of the signal.

The model may comprise a component and the producing means may comprise means for determining a value of a parameter of the component. The comparing means may comprise means for comparing the determined value of the parameter to a predetermined value of the parameter. A component may be determined to represent a signal due to the phenomenon if the value of the parameter of that component is within a given range of the predetermined value of the parameter. The predetermined value of the parameter may be a value that the parameter would be expected to take if the component represented a signal due to the phenomenon. The apparatus may further comprise means for determining the predetermined value of the parameter.

The comparing means may be adapted to determine whether the model represents a signal due to the phenomenon in dependence upon the number of components which are determined to represent a signal due to the phenomenon.

The producing means may comprise means for determining values of a plurality of parameters of a component, and the comparing means may comprise means for comparing the determined values of the parameters to predetermined values of the parameters.

A parameter may be selected from at least one of frequency, amplitude, phase and damping factor. A component of the model may be a decaying sinusoid.

The apparatus may further comprise means for inverting the signal and means for producing a model of the inverted signal. The apparatus may further comprise means for comparing a sign of the damping factor of the model to a sign of the damping factor of the model of the inverted signal.

The producing means may comprise means for carrying out a statistical time domain technique. The statistical time domain technique may be of a type which does not involve a transformation of the signal into the frequency domain. For example, the statistical time domain technique may be a Linear Prediction method or a Matrix Pencil method.

The apparatus may be apparatus for testing the sample, and may further comprise means for applying excitation to the sample and means for detecting the response to yield the signal. This important aspect is provided independently.

In a further apparatus aspect of the present invention there is provided apparatus for analysing a signal to test a sample, the apparatus comprising detecting means (such as a detector) for detecting a signal comprising a resonance response from the sample, producing means (such as a suitably programmed processor) for producing a model of the signal, storing means (such as a store) for storing a predetermined model of a signal due to a phenomenon, and comparing means (such as a comparator, which may be a processor, for example, the same processor as the producing means) for comparing the model to the predetermined model to determine whether the model represents a signal due to that phenomenon. Preferably, the apparatus further comprises applying means for applying excitation to the sample to excite the resonance response.

The apparatus may be adapted to select the predetermined model in dependence on the test conditions.

The apparatus may be adapted to compare the model to a predetermined model of an undesired signal and to apply further excitation in dependence on the result of the comparison. Preferably, the further excitation is such as to reduce the effect of the undesired signal.

The apparatus may be, for example, a magnetic resonance apparatus, or a quadrupole resonance apparatus.

The apparatus may be apparatus for detecting the presence of a sample in a larger sample which is not known to contain the sample. Thus there may be provided apparatus for detecting the presence of a sample in a larger sample which is not known to contain the sample, comprising detecting means for detecting a signal comprising a response from the sample, producing means for producing a model of the signal, storing means for storing a predetermined model of a response from the sample, and comparing means for comparing the model to the predetermined model to determine whether the sample is present. The apparatus may further comprise means for providing an alarm signal if the sample is determined to be present.

The apparatus may be apparatus for nuclear quadrupole resonance testing a sample containing quadrupolar nuclei, which sample may give rise to spurious signals which interfere with response signals from the quadrupolar nuclei, and the apparatus may comprise:
means for applying a pulse sequence to the sample to excite nuclear quadrupole resonance, the pulse sequence comprising at least one pair of pulses;
means for detecting response signals; and
means for comparing, for the or each such pair, the respective response signals following the two member pulses of the pair;
and the pulse sequence may be such that the respective spurious signals following the two member pulses can be at least partially cancelled by the comparing means without the corresponding true quadrupole resonance signals being completely cancelled.

For the or each such pair, the two member pulses may be of like phase. For the or each such pair of pulses, a respective pulse preceding each member pulse of the pair may be of differing phase. The or each such pair of pulses may be of a first type, and the pulse sequence may further comprise at least one further second type pair of pulses, corresponding to the or each first type pair, but having cycled phases.

Method features may be applied to the apparatus aspects and vice versa.

The invention extends to a computer readable medium having stored thereon a program for carrying out any of the methods described herein.

The invention extends to a computer program for carrying out any of the methods described herein.

The invention extends to a signal embodying a computer program for carrying out any of the methods described herein.

Preferred features of the present invention will now be described, purely by way of example, with reference to the accompanying drawings, in which:—

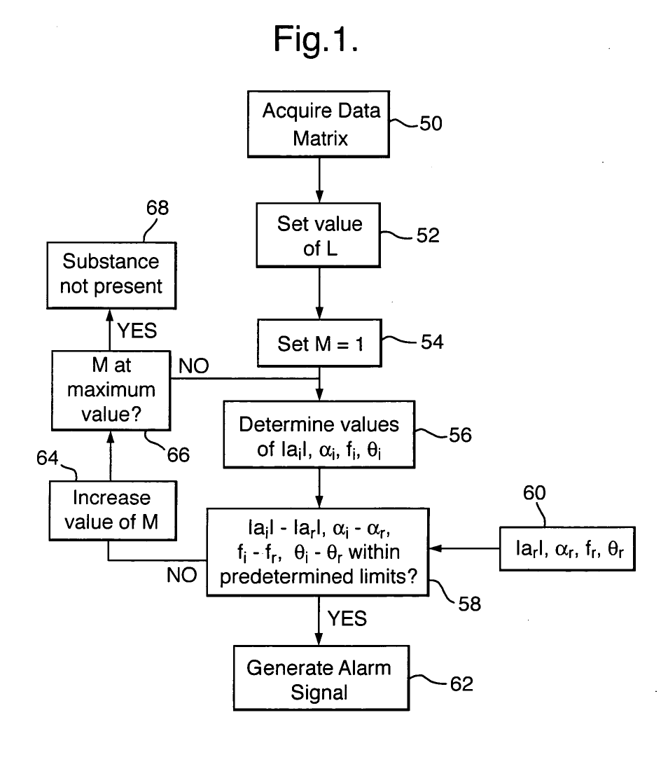

FIG. 1 illustrates a preferred embodiment of the invention;

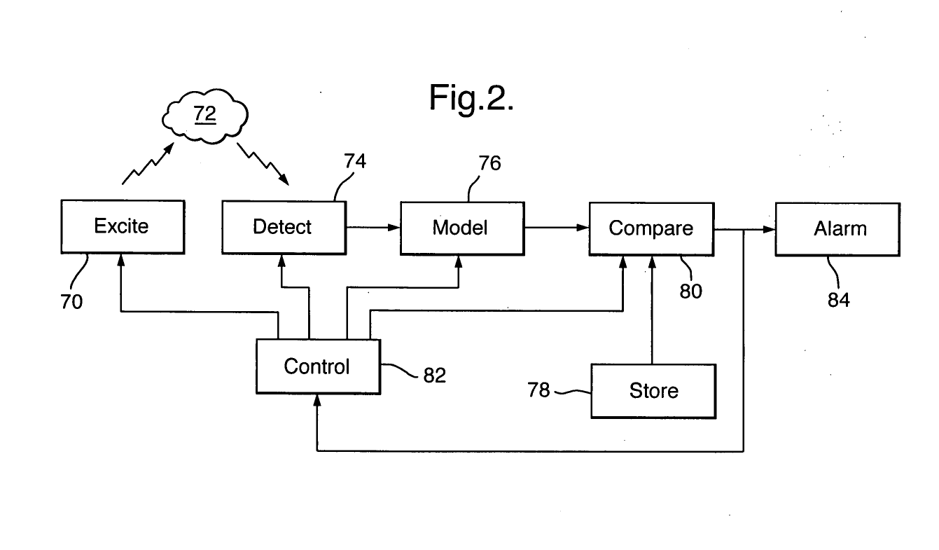

FIG. 2 is a block diagram of a preferred apparatus embodiment;

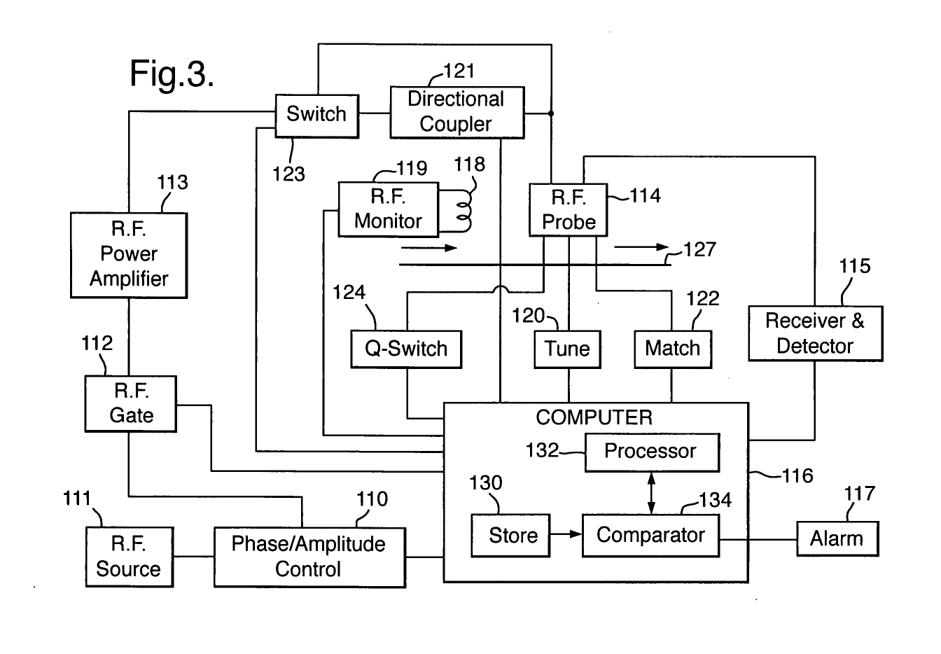

FIG. 3 is a block diagram of a QR testing apparatus suitable for use with the present invention;

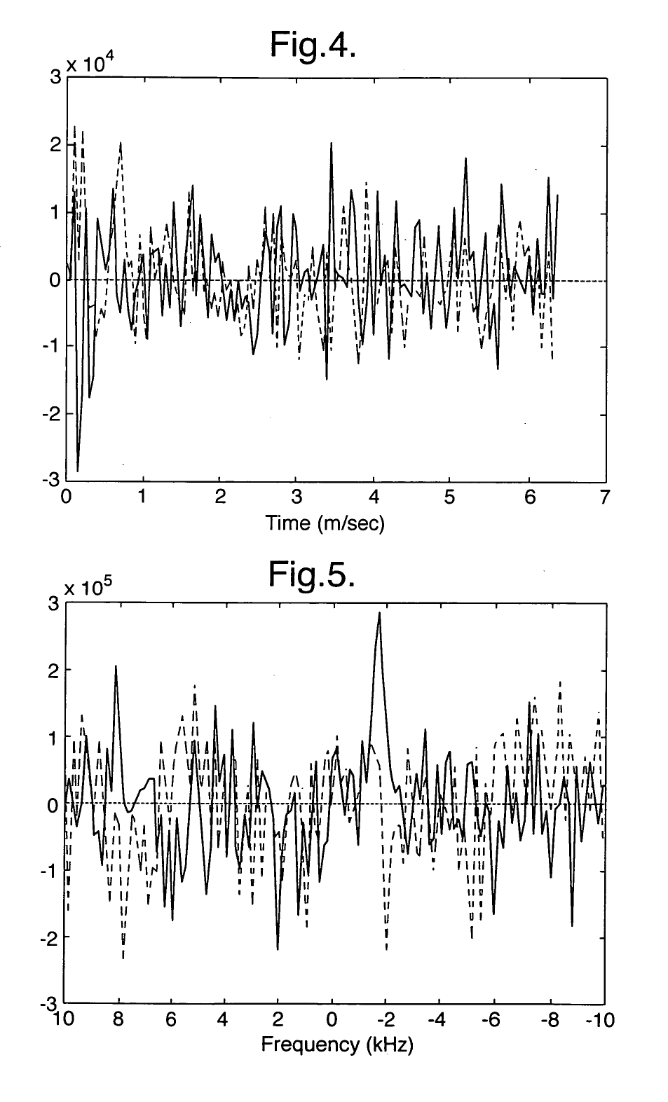

FIG. 4 shows a ¹⁴N FID for the 870 kHz line of TNT;

FIG. 5 shows the Fourier Transformation of the signal of FIG. 4;

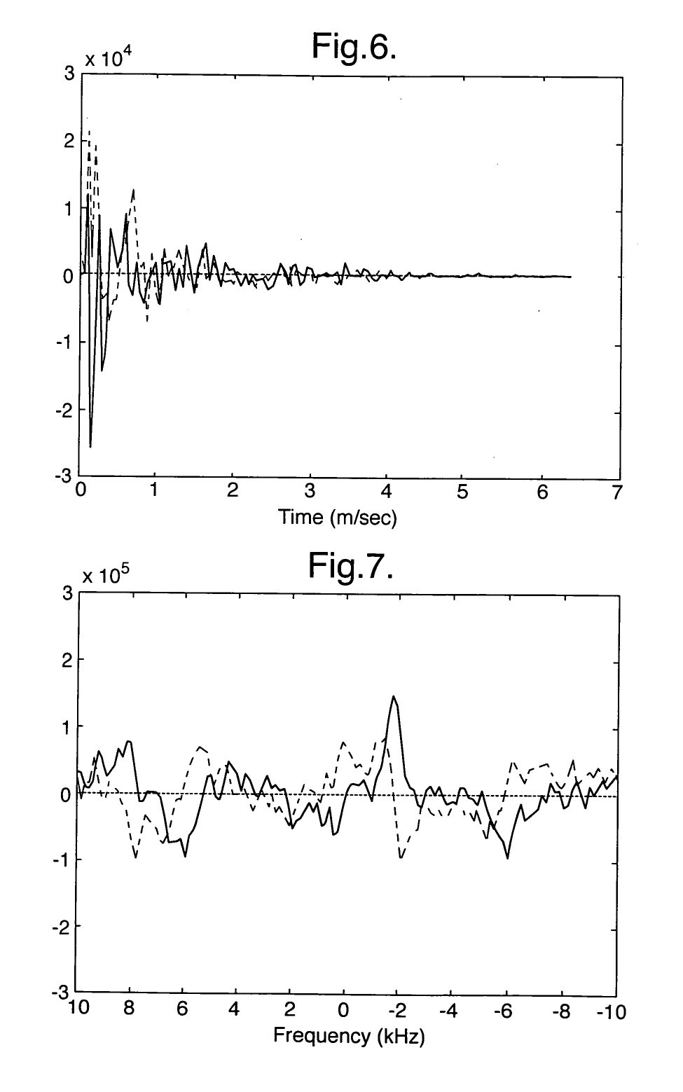

FIG. 6 shows the result of applying a matched filter to the signal of FIG. 4;

FIG. 7 shows the Fourier Transformation of the signal of FIG. 6;

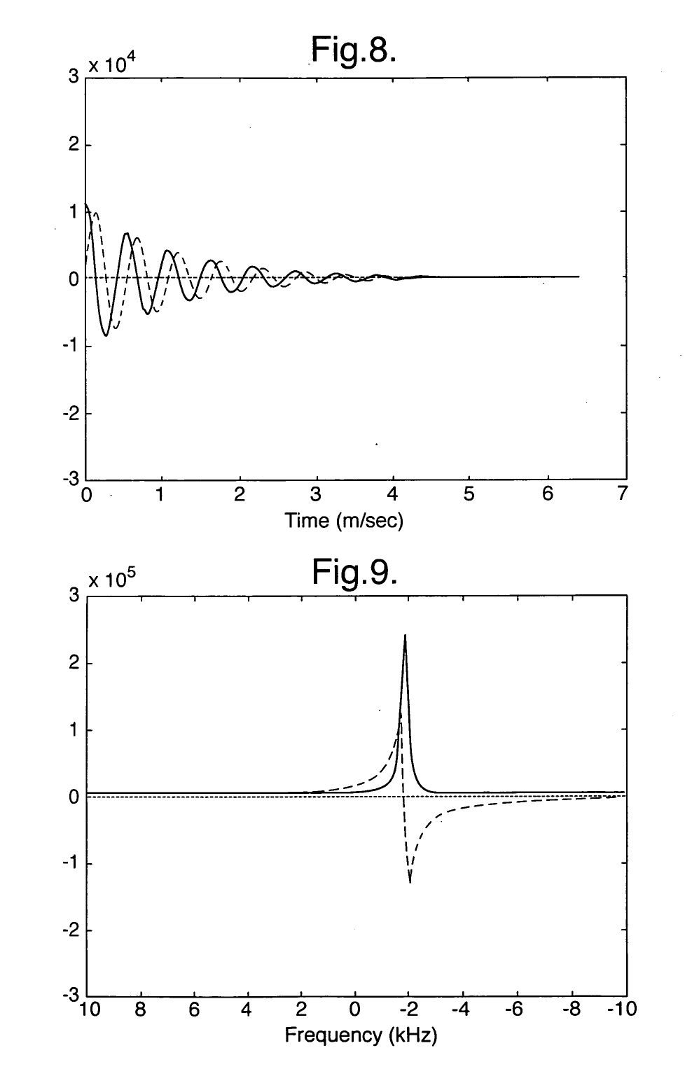

FIG. 8 shows the Linear Prediction Singular Value Decomposition (LPSVD) signal of the data of FIG. 4 with M=1;

FIG. 9 shows the Fourier Transformation of the signal of FIG. 8;

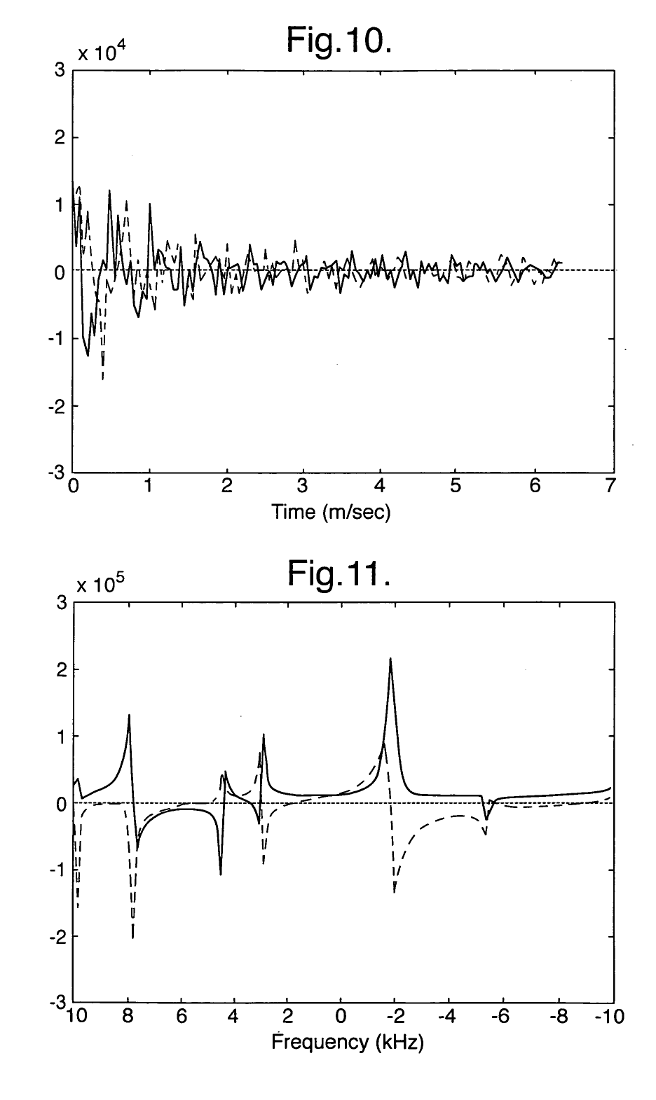

FIG. 10 shows the LPSVD signal of the data of FIG. 4 with M=8; and

FIG. 11 shows the Fourier Transformation of the signal of FIG. 10.

For the sake of convenience, present embodiments will be described with reference to Quadrupole Resonance (QR) techniques; however it will be appreciated that similar considerations apply to other techniques where a response from a sample is to be analysed.

QR testing may be used for detecting the presence of specific substances, and in particular polycrystalline substances. It depends on the energy levels of quadrupolar nuclei, which have a spin quantum number I greater than ½, of which ¹⁴N is an example (I=1). ¹⁴N nuclei are present in a wide range of substances, including animal tissue, bone, food stuffs, explosives and drugs.

In conventional QR testing a sample is placed within or near to a radio-frequency (r.f.) coil and is irradiated with pulses or sequences of pulses of electro-magnetic radiation having a frequency which is at or very close to a resonance frequency of the quadrupolar nuclei in a substance which is to be detected. If the substance is present, the irradiant energy will generate a precessing magnetization which can induce voltage signals in a coil surrounding or adjacent the sample at the resonance frequency or frequencies and which can hence be detected as a free induction decay (FID) during a decay period after each pulse or as an echo after two or more pulses. These signals decay at a rate which depends on the time constants T₂* for the FID, T₂ and T₂ₑ for the echo amplitude as a function of pulse separation, and T₁ for the recovery of the original signal after the conclusion of the pulse or pulse sequence.

According to a preferred embodiment, a QR response signal is first obtained by irradiating a sample with excitation and sampling the response to the excitation.

It is then assumed that the QR response signal d=|d₀, d₁, . . . d_{N-1}|^{T} (where T denoted the transpose of the matrix) can be represented by a sum of complex noise-free signals x=|x₀, x₁, . . . x_{N-1}|^{T} and an additional noise perturbation w=|w₀, w₁, . . . W_{N-1}|^{T} where N is the number of data points. It is also assumed that the QR response signal can be modelled by a set of M exponentially damped sinusoids of the form

$${d}_{n} = {x}_{n} + {w}_{n} = {\sum }_{i = 1}^{M} \vert {a}_{i} \vert exp ( j {θ}_{i} ) exp [ ( - {α}_{i} + j 2 π {f}_{i} ) n ] + {w}_{n} , \\ n = 0 , 1 , … , N - 1$$

in which |aᵢ|, αᵢ, fᵢ, and θᵢ represent the absolute amplitudes, damping factors, frequencies and phases of the M distinct components, respectively.

A statistical time domain technique is then used to fit the model (consisting of M exponentially damped sinusoids) to the QR signal. Such techniques typically yield m values of each of the parameters |a|, α, f, and θ, where m≦M.

In the present embodiment, M is initially set to a number, which may be the expected number of QR responses. For example, if the QR response is expect to display a single well defined line then M may be initially set to 1, whereas if the response is expected to display a number of lines or to be more complex in structure then M may be set to a higher number. If undesired signals are expected, M may be set to a higher value than the expected number of QR lines. The statistical time domain technique thus yields up to M values of each of the parameters.

The m sets of values of the parameters |a|, α, f, and θ are then compared to predetermined values of the parameters. If the values fall within acceptable ranges of the predetermined values of the parameters then it is judged that the model has been fitted to the QR response signal. Information about the QR response signal may then be obtained from the model. For example, if the technique is to be used in imaging, then the value of the amplitude may be taken to represent the density of the quadrupolar nuclei, or if the technique is to be used to detect the presence of the substance, then the fact that the values fall within acceptable ranges of the predetermined values of the parameters may be taken as an indication that the substance is present.

If the values do not fall within acceptable ranges of the predetermined values of the parameters then the number M of sinusoids in the model is increased and the statistical time domain technique is used to fit the new model to the QR signal, thereby producing another m sets of values of the parameters |a|, α, f, and θ.

Each of the m new sets of values is then compared to the predetermined values of the parameters. If any one of the m sets has parameter values which fall within acceptable ranges of the predetermined values then it is judged that the corresponding sinusoid has been fitted to the QR response, and thus those parameter values may be used to provide information about the QR response.

If none of the m sets has parameter values which fall within acceptable ranges of the predetermined values then the above steps are repeated for increasing values of M, until either a set of values if found which does fall within acceptable ranges of the predetermined values, or until M has reached its maximum value.

If the QR response is expected to display a number of lines, then various sets of predetermined values of the parameters |a|, α, f, and θ are provided, each corresponding to a particular line. The QR response is taken to be modelled when, for each set of predetermined values, there exists a set of parameter values which fall within acceptable ranges of those predetermined values. In this case the QR response is only taken to be modelled when a sinusoid has been fitted to each of the lines.

In an alternative embodiment, the values of M are increased in large steps until a value of at least one of the parameters (for example, phase) is found which is within a certain range, which may be the same as or larger than the acceptable range for that parameter. Thereafter the values of M are increased or decreased in smaller steps until a set of values if found which falls within acceptable ranges of the predetermined values.

The predetermined values are determined in advance by performing tests on a sample of the substance in situations where the QR response signals have a high SNR, for example about 60, and determining the values of |a|, α, f, and θ from the response signals using a statistical time domain technique. The acceptable ranges are then chosen to be consistent with the selected success rate for the tests.

The predetermined values may be provided in the form of a look up table, or tests may be performed prior to detection in order to provide predetermined values which correspond to the conditions under which detection is performed. The predetermined values may differ according to the conditions under which the test is performed, for example, according to the particular pulse sequence which is used. Thus, when comparing the values of the parameters to the predetermined values of the parameters, the values of the predetermined parameters which correspond as far as possible to the actual conditions under which the test is performed are used.

Any suitable statistical time domain technique which can fit the model to the response signal may be used. However, particularly preferred examples are Linear Prediction and the Matrix Pencil Method, although other techniques such as Maximum Likelihood or Variable Projection (which are known in the art) could also be used.

Linear Prediction (LP) methods of data processing represent each value in a time series, such as an FID or echo, by some fixed linear combination of the immediately preceding or following values. In “forward” LP, each data point dₖ is represented as the linear sum of a number of forward data points:

$${d}_{k} = {\sum }_{i = 1}^{L} {a}_{i} {d}_{k - i}$$

$$k = L , … , N - 1$$

where d=|d₀, d₁, . . . , d_{N-1|}^{T} is the time series, aᵢ; are the LP coefficients (sometimes referred to as the linear prediction filter), L is the number of prediction coefficients, known as the prediction order, and N is the number of data points.

In “backward” LP, each data point dₖ is represented as the linear sum of a number of backward data points:

$${d}_{k} = {\sum }_{i = 1}^{L} {b}_{i} {d}_{k + i}$$

$$k = 0 , … , ( N - L ) - 1$$

The class of time series that obeys the LP equations coincides with the class of sums of exponentially decaying (or growing) sinusoids, so that LP can be used to provide estimates of the parameters |aᵢ|, αᵢ, and θᵢ for i=0, 1, . . . , M. In general, M<L<N.

The forward LP equation can be written in matrix form as Da=d′, where

$$D = \vert \begin{matrix}{d}_{0} & {d}_{1} & … & {d}_{L - 1} \\ {d}_{1} & {d}_{2} & … & {d}_{L} \\ ⋮ & & & \\ {d}_{N - L - 1} & {d}_{N - L} & … & {d}_{N - 2}\end{matrix} \vert , a = \vert \begin{matrix}{a}_{L} \\ {a}_{L - 1} \\ ⋮ \\ {a}_{1}\end{matrix} \vert , {d}^{l} = \vert \begin{matrix}{d}_{L} \\ {d}_{L + 1} \\ ⋮ \\ {d}_{N - 1}\end{matrix} \vert$$

This equation may be solved for a using a least squares method. The solution is given by
a=(D^{†}D)⁻¹D†d′
where D^{†} is the Hermitian transpose of D (that is, the complex conjugate of the transpose of D).

Various techniques may be used to invert the matrix D⁵⁵⁴D. In the present embodiment, Singular Value Decomposition (SVD) is used, although other techniques such as Householder QR decomposition or Cholesky decomposition could be used. SVD takes the form
D=UΛV^{†}
where U and V are unitary matrices and Λ is a diagonal matrix of the singular values λ₁, . . . , λ_{L}. Each singular value corresponds to a component in the data matrix. The larger singular values are usually associated with genuine signal components and the smaller with noise, although in situations where there is a low SNR this clear distinction may not hold. SVD retains only the M largest entries in the matrix of singular values, and sets the L-M smaller entries to zero before solving for the linear prediction coefficients. The so-called signal poles
zᵢ=exp(−αᵢ+j2πfᵢ)
are then derived from the roots of the prediction polynomial
z^{-M}−b₁z^{-M+1}− . . . −b_{M}z⁰=0
the coefficients of which are the linear prediction coefficients. The complex amplitudes and phases are then evaluated and the results output as a table of m values of |a|, α, f and θ.

In the present embodiment, the value of M is varied from its minimum value (usually one) up to the maximum allowed (usually N/3 for low SNR), searching each output of m values of each of |a|, α, f, and θ for a set that lies within the allowed ranges for the substance to be detected.

The Matrix Pencil method (MPM) takes two noise free data matrices, X₀ and X₁, of dimension (N−L)×L and forms the matrix pencil X₁−λX₀, where λ is a scalar variable. This is written in the form

$${X}_{1} - λ {X}_{0} = {Z}_{L} B \vert \begin{matrix}{z}_{1} - λ & 0 & … & 0 \\ 0 & {z}_{2} - λ & … & 0 \\ ⋮ & ⋮ & ⋮ & ⋮ \\ 0 & 0 & … & {z}_{M} - λ\end{matrix} \vert {Z}_{R}$$

where Z_{L} and Z_{R} are Vandermonde matrices and B is a diagonal matrix constructed from the complex amplitudes. The rank of the matrix pencil is M, except when λ=zᵢ, when it reduces to M−1. Each of the M values of zᵢ, the signal poles, is therefore identified as a rank-reducing number of the matrix pencil X₁−λX₀. The presence of noise is allowed for by replacing X₀ and X₁ by Y₀ and Y₁, whose elements are the experimentally observed QR signal y and which are now of full rank due to noise contamination. SVD is then used to restore the original matrix rank, as in the case of LPSVD discussed above. The result is an L×L matrix product with M non-zero eigenvalues representing the signal poles zᵢ, where L is the pencil parameter.

As with LP, in the present embodiment, the value of M is varied from its minimum value up to the maximum allowed, searching each output of M values of each of |aᵢ|, αᵢ, fᵢ, and θᵢ for a set that lies within the allowed ranges for the substance to be detected.

The Matrix Pencil method and Singular Value Decomposition are described in more detail in the paper by Hua et al IEEE Transactions on Signal Processing, Vol. 39, No. 4, April 1991, the subject matter of which is incorporated herein by reference.

FIG. 1 illustrates a preferred embodiment, in which the presence of a particular substance is to be detected. Referring to FIG. 1, in step 50 the data matrix is acquired by applying excitation to a sample and detecting the response. In step 52 the value of L is set. In the present embodiment, L is set to either ⅓ or ¼ of the number of data points N, such choices of L having been found to be appropriate when dealing with noisy signals. In step 54, the value of M is set. In the present embodiment, M is set initially to 1, although other initial values of M could be set. In step 56, the values of the parameter estimates |aᵢ |, αᵢ, fᵢ, and θᵢ are determined, for example using Linear Prediction Singular Value Decomposition or the Matrix Pencil method. A set of m values of |aᵢ|, αᵢ, fᵢ, and θᵢ is produced, where m≦M.

In step 58, the m sets of values of |aᵢ|, αᵢ, fᵢ, and θᵢ are compared to the predetermined values |αᵣ|, aᵣ, fᵣ, and θᵣ (represented by box 60). If one or more of the m sets of the parameter estimates has the property that |aᵢ|-|aᵣ|, αᵢ-αᵣ, fᵢ-fᵣ and θᵢ-θᵣ or lie within specified limits, then the substance is considered to have been detected and in step 62 an alarm signal is generated. If not, then in step 64 the value of M is increased. In step 66 it is determined whether M has reached its maximum allowed value. If so, then the substance is considered not to have been detected and in step 68 a signal indicating that the substance is not present is generated. If, at step 66, M has not reached its maximum value, then steps 56 onwards are repeated. Steps 56, 58, 64 and 66 are repeated for increasing M, until the substance is detected, or until M reaches its maximum allowed value. With each iteration, M may be increased by 1, or by some other value.

It should be noted that, particularly at low SNR, it is not necessarily the maximum value of M, consistent with a given L of N/3, that results in the substance being detected. Signals are sometimes detected at intermediate values of M, that is, between 1 and N/3−1, or even at just a single value of M.

In the present embodiment, values of each of the parameters, |aᵢ|; αᵢ, fᵢ and θᵢ are determined, and each of these is compared to the predetermined range of that parameter. However, the comparison may be carried out using any combination of the parameters; for example, only one, two or three of the parameters need be calculated and/or compared to the predetermined range. This may be appropriate where one or more of the parameters is deemed to be unreliable, or where it is desired to reduce the amount of computation or the number of predetermined ranges of parameters which are provided. In particular, the comparison may be carried out using only the parameters α and f, or f and θ, or α, f and θ.

If the technique is to be used for types of testing other than detection, then in step 62, rather than generating an alarm signal, the set of values of |aᵢ|, αᵢ, fᵢ, and θᵢ which relate to the substance are provided for further analysis. For example, the value of the amplitude |aᵢ| might be taken to indicate the number density of the quadrupolar nuclei. The other sets of values (where present) are taken not to relate to the substance, and thus these values can be ignored, or else used, for example, to give information about the undesired signals, as will be discussed below.

The present techniques may also be used to distinguish between noise, interference (from an external interference source) and spurious signals, as well as between different types of spurious signals, such as magneto-acoustic and piezo-electric responses. This is due to the discovery, pursuant to the present invention, that each of these types of signals may have distinguishing characteristics. For example, noise signals may have a positive value of a, whereas spurious signals and interference (along with the true response signals) usually have negative values of a. Interference signals from AM or FM radio stations tend to be a signal at one frequency with sidebands which average out to zero as the signal is accumulated. Magneto-acoustic spurious signals consist of a number of responses with no clearly defined relationship, and with decay constants which increase at low frequency. Piezo-electric spurious signals consist of responses across a wide of frequencies, but which become less serious at low frequencies and which tend to vanish below about 1 MHz. All of the above characteristics can be recognised by a suitably programmed computer. Knowledge of the type of undesired signal that is present can be used to adjust the experimental conditions to reduce the consequences of that particular type of signal.

For example, if interference is present, then a two-antenna probe may be used to reduce the interference, as described in co-pending International Patent Application no. PCT/GB99/00680 in the name of BTG International Limited, the subject matter of which is incorporated herein by reference. However use of such a probe may cause additional noise to be produced from the second antenna, leading to a reduction in the SNR. Thus, in situations where there are no strong interfering signals it may be preferred to use a single antenna whereas in situations where there are interfering signals a two-antenna probe may be preferred. The present techniques can determine whether or not interference is present, by comparing the values of the parameters to those that would be expected for interference, and the second antenna may then be switched in or out of the probe circuit as appropriate.

As mentioned above, spurious signals due to magneto-acoustic responses tend to die away more quickly at high frequencies. Thus, if magneto-acoustic responses are determined to be present, further experiments may be carried out using higher frequency QR lines where such responses will be less serious. For example, in the case of RDX, experiments may be carried out initially at the 3.4 MHz at room temperature line. If magneto-acoustic responses are determined to be present then further tests could be carried out at the 5.2 MHz at room temperature line.

Conversely, piezoelectric responses become less serious at low frequencies, and thus if such responses are determined to be present then further tests may be carried out at lower frequencies. For example, in the case of RDX, further tests might be carried out at the 1.8 MHz line if piezo-electric responses are determined to be present.

### Preferred Embodiment of Apparatus

Referring to FIG. 2, apparatus for detecting the presence of a sample in a larger sample which is not known to contain the sample comprises excitation applying means 70 for applying excitation to sample 72 and detecting means 74 for detecting a response to the excitation. Modelling means 76 produces a model of the detected response in the form of a number of parameter values. Store 78 stores values of predetermined parameters corresponding to expected responses from the sample, and also parameter values corresponding to the values that undesired signals such as noise, interference, magneto-acoustic signals and piezo-electric signals would take. Comparator 80 compares parameter values from the modelling means to predetermined values in store 78. Control means 82 controls the excitation applying means, the detecting means, the modelling means and the comparing means.

In operation, if the parameter values determined by the modelling means are within an allowed range of the predetermined parameter values corresponding to expected responses from the sample, then alarm means 84 generates an alarm signal to alert the operator to the presence of the substance. If the parameter values are within a range corresponding to expected ranges of undesired signals, then this information is conveyed to control means 82, and the excitation applying means 70 is adjusted appropriately, for example by changing the excitation frequency or by switching a second, interference cancelling, antenna into or out of the probe circuit, and applying further excitation.

Modelling means 76, store 78, comparator 80, and control means 82 may be implemented in hardware or by a suitably programmed computer.

Referring to FIG. 3, a specific embodiment of apparatus in the form of apparatus for QR testing includes a radio-frequency source 111 connected via a phase/amplitude control 110 and a gate 112 to an r.f. power amplifier 113. The output of the latter is connected to an r.f. probe 114 which contains one or more r.f. coils disposed about or adjacent the sample to be tested (not shown), such that the sample can be irradiated with r.f. pulses at the appropriate frequency or frequencies to excite nuclear quadrupole resonance in the substance under test (for example, an explosive). The r.f. probe 114 is also connected to r.f. receiver and detection circuitry 115 for detecting nuclear quadrupole response signals. The detected signal is sent from circuitry 115 to a control computer 116 for processing.

The control computer 116 also controls all pulses, their radio frequency, time, length, amplitude and phase. In the context of the present invention all of these parameters may need to be adjusted precisely; for example, phase may need to be varied in order to be able to generate echo responses.

Re-tuning of the r.f. probe 114, alteration of its matching and alteration of its Q factor may all need to be carried out dependent upon the nature of the sample. These functions are carried out by the control computer 116 as follows. Firstly, the computer checks the tuning of the r.f. probe 114 by means of a pick-up coil 118 and r.f. monitor 119, making adjustments by means of the tuning control 120. Secondly, the matching to the r.f. power amplifier 113 is monitored by means of a directional coupler 121 (or directional wattmeter), which the computer responds to via a matching circuit 122, which in turn adjusts the r.f. probe 114 by means of a variable capacitance or inductance. The directional coupler 121 is switched out by the computer 116 when not required, via switch 123. Thirdly, the Q factor of the r.f. coil is monitored by a frequency-switch programme and adjusted by means of a Q-switch 124 which either changes the coil Q or alternatively alerts the computer to increase the number of measurements.

The control computer 116 may be programmed to analyse the QR response signal in any of the ways to be described. In particular, the computer comprises a store 130 for storing predetermined values of the parameters |a|, α, f, and θ, a processor 132 for carrying out a statistical time domain technique such as LP or MPM to yield determined values of |a|, α, f, and θ, and a comparator 134 for comparing determined values of |a|, α, f, and θ with the predetermined values of |a|, α, f, and θ. The computer includes some means 117 for producing an alarm signal in dependence upon the result of the comparison. The alarm signal would normally be used to activate an audio or visual alarm to alert the operator to the presence of the substance under test.

Shown diagrammatically in FIG. 3 and designated as 127 is some means, such as a conveyor belt, for transporting a succession of samples to a region adjacent the r.f. probe 114. The computer 116 is arranged to time the application of the excitation pulses substantially simultaneously with the arrival of a particular sample adjacent the probe. In alternative embodiments, instead of the sample being carried on a conveyor belt, it may actually be a person, and the r.f. probe may be in the form of a walk-through gateway or a hand-held wand. In a further embodiment, the probe itself may be moved over objects or terrain at a predetermined rate.

The apparatus described above may employ rectangular pulses, or any other suitable pulse shapes. Furthermore although usually the radio-frequency probe would utilise a single coil for both transmission and reception of signals, any appropriate number of coils may be used, and different coils can be used for transmission and reception. The coils may be in the form of a single turn, a planar spiral antenna, a loop gap or split ring resonator, and any other appropriate design. For NQR testing, the apparatus would usually operate in the absence of any applied magnetic field.

Experiments

In order to demonstrate the present techniques, various tests were carried out on a sample of RDX using a Tecmag “Libra” spectrometer. The sample occupied a volume of 120 cm³ and was contained in a cylindrical glass bottle, which was positioned inside the solenoid of the r.f. probe. Except where stated, the experiments were carried out at or close to the 3.41 MHz at room temperature line of RDX. In order to minimise the reflected power at this frequency, the probe was tuned using a PTS 310 Frequency Synthesizer together with a directional coupler and an oscilloscope.

The excitation sequences and the data acquisition were controlled by MacNMR 5.4 software implemented on a Power Macintosh 7600/132. In order to generate FIDs, the spectrometer was programmed to provide 1 r.f. pulse per scan. A pulse width of 170 μs was used, which is consistent with the realisation of the maximum intensity of the FID. Acquisition of the FID began 270 μs after the end of the r.f. pulse to avoid acquiring breakthrough of the pulse into the FID. The dwell time (sampling interval) was 5 μs and the number of data points acquired per scan was 1024, giving a total acquisition time interval of 5.12 ms.

Cycling of both the transmitter and receiver phases was carried out to cancel baseline offset in the FID. Phase cycling is described in International Patent Application Number WO 96/26453, cited above. In the present experiments, the phase cycle (x, y, −x, −y) was used for both transmitter and receiver.

The delay between consecutive scans was chosen to be greater than the time constant T₁ in order to allow time for the nuclear spins to return to thermal equilibrium after the r.f. pulse. The sequence repetition delay was set to 30 ms, which is about 2.5 T₁ for RDX at room temperature, T₁ for RDX at room temperature being about 12 ms.

For the purpose of estimating the r.m.s. noise, 1000 scans were performed with the excitation frequency set to the ¹⁴N QR frequency of RDX at room temperature. The resulting data were baseline corrected to remove from the FID any residual baseline offset that had not been eliminated by the phase cycling. The r.m.s. noise after 1000 scans was estimated to be ⅕ of the peak-to-peak noise in the real part of the baseline corrected data averaged over 10 zero crossings.

In order to obtain time domain data having suitably low SNRs, the sample was partially removed from the coil. 10000 scans were performed, after which the resulting data were baseline corrected. The maximum magnitude of the baseline corrected FID was determined and divided by 10 to give a measure of the signal obtained in the time domain in 1000 scans. Having found both the signal and the r.m.s. noise obtained after 1000 scans, the time domain SNR (defined as the maximum magnitude of the FID divided by the r.m.s. noise) that is realised in 1000 scans was readily derived. Using the fact that the SNR is proportional to the square root of the number of scans, appropriate numbers of scans were performed so as to obtain data sets having the desired time domain SNRs. In this way, data sets with SNRs of 1.5, 1, 0.7 and 0.5 were created. After removing the sample from the coil, data sets consisting of noise alone were produced.

To produce data sets with a QR SNR of 1 and various degrees of contamination from piezoelectric signals, the RDX sample was positioned only partially within the coil and the number of scans required to achieve an SNR of 1 was determined, as described earlier. A jar of sand was then placed either close to or partially inside the coil, depending on the required degree of contamination. 1000 scans were then performed and the resulting data baseline corrected. The difference between the maximum magnitude of the baseline corrected data and the measure of the QR signal obtained in the time domain in 1000 scans that had been found previously was taken as a measure of the spurious signal obtained in 1000 scans. In this manner data sets having piezoelectric-to-QR signal ratios of 1, 1.6, 2.1, 4.3, 6.0, 9.6, 13.6 and 34.1 were created, the number of scans being such that the QR SNR was 1 in each case. By removing the RDX sample from the coil, data sets consisting only of piezoelectric signals and noise were produced, the piezoelectric SNR being approximately 1.

By using nickel screws instead of sand, data sets with an QR SNR of 1.5 and a magnetoacoustic-to-QR signal ratio of 1.2 were created using methods similar to those described above. Additional data sets containing only magnetoacoustic signals plus noise were produced with a magnetoacoustic SNR of about 1.5.

Three further data sets, contaminated to differing degrees by interference, were obtained after removing the shield from the probe. The contaminated data sets were such that, had the shield not been removed from the probe, the estimated SNRs would have been 34, 17 and 8 respectively.

Echoes were generated by means of a PAPS, NPAPS, NPAPS steady state free precession sequence. This has the basic form
{[P1−τ−P2−τ−]n}N_{S}
where P1 and P2 are r.f. pulses, of the same length but different phase cycling, separated by the time r, the loop count parameter n is the number of times per scan that the 2 pulse unit enclosed in [ ] is implemented, and Nₛ, which is a multiple of 4, is the number of times that the sequence enclosed in { } is executed, that is, the number of scans. The phase cycling can be written as
{[P1(PhP1)−Data(PhD1)−P2(PhP2)−Data(PhD2)−]n}Nₛ

where Ph indicates phase. The r.f. and data go through the 4 phase cycle indicated in the table below.

| PhP1 | PhD1 | PhP2 | PhD2 |
|---|---|---|---|
| 0° | 0° | 180° | 180° |
| 180° | 180° | 0° | 0° |
| 0° | 180° | 0° | 180° |
| 180° | 0° | 180° | 0° |

The phase cycling eliminates the FID signals and hence spurious responses which follow the phase of the r.f. The acquired QR signal is formed from the steady state transverse magnetisation and is of echo character. The signal collected is the first half of the refocusing echo and looks like a reversed FID.

The length of the pulses P1 and P2 was chosen to be 170 μs. The time interval between the end of each r.f. pulse and the start of the subsequent data acquisition was 190 μs, during which the signal averager was reset to effect summation of the echoes. With the dwell time set to 1.2 μs, the number of data points to be obtained per acquisition was established as 500 so that the acquisition time interval was 600 μs. The delay τ between pulses was set to 1 ms, whilst the loop count parameter n was fixed at 46. The delay between consecutive scans was chosen to be 75 ms. With a 38 g sample of RDX positioned inside the coil, echoes were obtained on resonance with SNRs of 3, 2, 1 and 0.5, following similar methods to those described earlier.

In order to facilitate determination of the reference parameters describing the ¹⁴N QR signals from RDX, additional FIDs and echoes having a high SNR of about 60 were created by performing 1000 scans with the 120 cm³ RDX sample fully inserted into the coil.

Parametric MPM was implemented in MATLAB using the function ITMPM. This function accepts 2 input arguments, the complex vector y which represents the time domain data, and the real scalar M which is the number of signal components for which parameter estimates are required. The program listing is given in Annex 1, representing an information-theory based version of the matrix pencil method (ITMPM), slightly modified for the present application.

In analysing the FIDs, an QR signal was initially considered to have been detected if the following conditions were satisfied
4×10⁻⁰³<α<1.7×10⁻⁰²
−1×10⁻⁰³<f<1×10⁻⁰³
(frequency in units of the sampling interval Δt). The linewidth Δf and the frequency in Hertz f_{H} of the component are related to α and f by

$$Δ f = \frac{{α}_{1}}{π Δ t} , {f}_{H} = \frac{f}{Δ t}$$

For Δt=5 μs these values correspond to a linewidth of between 255 and 1082 Hz and a frequency of less than 1 kHz off-resonance.

In the first instance, analysis was carried out using all 512 data points, that is, with N=512. All measurements were performed on or close to resonance. In real situations where the temperature of the sample is not known, it may not be possible to satisfy this criterion, in which case it may be an advantage to shift the frequency and repeat the data analysis until a signal is identified.

The FIDs having SNRs of 0.5, 0.7 and 1 were processed by ITMPM, using N=256 and 512, L=N/3. For each data set, values of M of 1, 2, 4, 8, 16, 32, 64 and 84 were used in the first instance, along with the intermediate values 24, 48 and 74. If no QR signal could be found, then of the 10 values of M already tried, those values Mⱼ which at least yielded a decaying component for which |f|<1×10⁻⁰³ were recorded. For each of the Mⱼ, processing was then effected repeatedly using the progressively decreasing values Mⱼ₋₁, Mⱼ₋₂, . . . until either the QR signal was retrieved or no decaying component for which |f|<1×10⁻⁰³ was returned. If still the QR signal had not been detected, then the progressively increasing values Mⱼ₊₁, Mⱼ₊₂, . . . were also utilised.

The success rate for detecting the QR signal was found to be 65% for a SNR of 0.5, and 100% for SNRs of 0.7 and 1, demonstrating the suitability of the technique for detecting QR response signals. Inverting the data matrix was found to change the sign of a for the QR signal, while the signs of the noise components remained unchanged, providing (under those conditions) a further method of distinguishing signal from noise.

The data sets with a QR SNR of 1 and piezoelectric-to-QR signal ratios of 1, 1.6, 2.1, 4.3, 9.6, 13.6 and 34.1 were then processed using ITMPM with N=512 and 256, L=N/3 and several different values of M, in the manner described previously. 2 data sets were processed for each of the 7 values of the piezoelectric-to QR signal ratio. The QR signal was recovered in all cases.

The same processing strategy was applied to the 10 data sets consisting only of piezoelectric signal and noise. An QR signal appeared to be present in 2 of the data sets, that is, the false alarm rate was 20%.

The relatively poor false alarm rate that occurred in the presence of sand motivated the introduction of phase information into the detection process. It was decided that an QR signal should only be considered to have been detected when ITMPM has identified a decaying component for which the following conditions where satisfied
4×10⁻⁰³<α<1.7×10⁻⁰²,
|f|<1×10⁻⁰³, and
θ_{c}−0.5≦θ≦θ_{c}+0.5
where the “true” phase θ_{C} of an QR signal is obtained by ITMPM from a data set having a high SNR of approximately 60. θ_{c} depends on the spectrometer and the temperature-dependent QR frequency, but was typically found to be about −2 rad. When all 3 of the above criteria were imposed during processing, an QR signal did not appear to be present in any of the 10 data sets consisting of piezoelectric signals and noise alone.

The 10 data sets with an QR SNR of 1.5 and a magnetoacoustic-to-QR signal ratio of about 1.2 were processed by ITMPM with N=512, L=N/3 and many different values of M. The 3 constraints given above were imposed on the parameters α, f and θ during processing. The QR signal was detected in 80% of the data sets. Similarly, processing 10 data sets consisting of magnetoacoustic signals plus noise, the magnetoacoustic SNR being approximately 1.5, yielded a false alarm rate of 30%.

The above results demonstrate that, even when piezoelectric and magneto-acoustic responses have been minimized by phase cycling, MPM will provide even further discrimination of the true NQR signal.

In analysing the echoes, an QR signal was considered to have been detected if a component for which the following conditions where satisfied. Note that the conditions are not necessarily the same as when FIDs are being detected.
α<0, and
−1×10⁻⁰³<f<1×10⁻⁰³.

Analysis was carried out with N=500 and L=N/3. 10 echoes having an estimated SNR of 1.5 were processed by ITMPM with values of M no greater than 2. The QR signal was recovered in all 10 cases. When M was set equal to 100, only the QR signal had a positive value of a (as defined previously), as expected in SSFP sequences; all the noise components had negative α, providing a strong criterion in identifying an QR signal and rejecting spurious responses (for which α is usually negative) when at or close to resonance.

10 echoes having an estimated SNR of 0.7 were processed by ITMPM using many different values of M, following the methods described previously. The QR signal was detected in 50% of the data sets.

In order to compare the present techniques with the performance of a matched filter, parametric LP was implemented in MATLAB using the function LPSVD, and tests were carried out using the 870 kHz line of TNT. In the LP function, the linear prediction order L was set to either N/3 or N/4, these values being suited to the processing of noisy signals. FIG. 4 shows the original time domain data, which had a SNR of about 5. The Fourier Transformation (FT) of these data is shown in FIG. 5, with the QR response at −2 kHz on the frequency scale. FIG. 6 shows the original time domain data multiplied by a matched filter with a time constant of 1.5 ms; the SNR has improved by a factor of about 20. FIG. 7 shows the FT of the data of FIG. 6. FIG. 8 shows the LPSVD signal in the time domain with M=1, and FIG. 9 shows the FT. In this case the program has selected the correct component as the signal. FIG. 10 shows the time domain LPSVD signal with M=8; the signal is a better fit to the actual FID, as shown in FIG. 3. The Fourier Transformation is shown in FIG. 10. The noise components are evident, but clearly distinguished from the true signal by their line width, frequency and phase. At higher values of M, the clutter in the FT spectrum renders a visual inspection almost impossible, but the true signal may be distinguished by comparison of the parameter values with predetermined values of the parameters.

While embodiments have been described with reference to QR techniques, similar considerations apply to other techniques where a response is analysed. For example, in the case of MR a major application is in the detection of signals from a given nucleus in very low abundance, for example ²⁹Si (=½) in rocks. This is the only isotope of this element with a nuclear magnetic moment, but it has an abundance of only 4.7%. Another example is the detection of dopants at very low levels of doping, for example hydrogen-doped boron.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

function [para,M,itc]=itcmp(y,M)
y=y (:) ;N=length(y) ;
L=floor(N/3)
Y=toeplitz(y(L+1:N) ,y(L+1:−1:1));
[U,S,V]=svd(Y(:,2L+1) ,0);
S=diag(S);
itc=zeros(1,L);
if M==−1

for k=0:L−1;

itc (k+1) =−2*sum(log(S(k+1:L)))...
+2*N* (L−k) *log ((sum(S(k+1:L))/(L−k)))+2*k* (2*L−k);

end
[tempY,tempI]=min (itc) ;M=tempI−1;

end
if M==−2

for k=0:L−1;

itc (k+1) =−N*Sum(log(S(k+1:L)))...
+4N* (L−k) *log((sum(S(k+1:L))/(L−k)))+k* (2*L−k) *log(N) /2;

end
[tempY,tempI] =min(itc) ;M=tempI−1;

end
s=log(eig(diag(1./S(1:M))*...
((U(:,1:M) ′*Y(:,1:L))*V(:,1:M)));
Z=zeros(N,M);
for k=1:M;Z(:,k) =exp(s(k)).\hat{ }[0:N−1].′end;
a=Z\y;
para=[−real (S) imag (s)/2/pi abs(a) imag(log(a./abs(a)))];
return

1. A method of analysing a signal obtained by applying excitation to a sample and detecting a resonance response, the method comprising:
producing a model of the signal; and
comparing the model to a predetermined model of a signal due to a phenomenon, thereby to determine whether the model represents a signal due to that phenomenon.

2. A method according to claim 1 wherein the predetermined model is a predetermined model of a response from a particular sample and the comparing step is to determine whether the model represents a response from the particular sample.

3. A method according to claim 1 wherein the signal comprises a response from a sample and an undesired signal and the comparing step is to distinguish the response from the undesired signal.

4. A method according to claim 3 wherein in the producing step the model models the response and the undesired signal.

5. A method according to claim 1 comprising the steps of comparing the model to a predetermined model of a response from a sample, and comparing the model to a predetermined model of an undesired signal.

6. A method according to claim 1 wherein the producing step and the comparing step are carried out with models having increasing numbers of components.

7. A method according to claim 1 wherein the producing step is carried out using a statistical time domain technique.

8. A method according to claim 1 being a method of testing a sample, further comprising applying excitation to the sample and detecting the response to yield the signal.

9. A method of analysing a signal to test a sample, the method comprising:
detecting a signal comprising a resonance response from the sample;
producing a model of the signal; and
comparing the model to a predetermined model of a signal due to a phenomenon, thereby to determine whether the model represents a signal due to that phenomenon.

10. A method according to claim 8 wherein the model is compared to a predetermined model of an undesired signal, the method further comprising applying further excitation in dependence on the result of the comparison.

11. A method according to claim 8 wherein the excitation is arranged to excite quadrupole resonance.

12. A method of detecting the presence of a sample in a larger sample which is not known to contain the sample, comprising:
detecting a signal comprising a response from the sample;
producing a model of the signal; and
comparing the model to a predetermined model of a response from the sample, thereby to determine whether the sample is present.

13. A method according to claim 12 further comprising providing an alarm signal if the sample is determined to be present.

14. A method according to claim 1 wherein the method is a method of nuclear quadrupole resonance testing a sample containing quadrupolar nuclei, which sample may give rise to spurious signals which interfere with response signals from the quadrupolar nuclei, the method further comprising:
applying a pulse sequence to the sample to excite nuclear quadrupole resonance, the pulse sequence comprising at least one pair of pulses;
detecting response signals; and
comparing, for the or each such pair, respective response signals following the two member pulses of the pair;
the pulse sequence being such that respective spurious signals following the two member pulses can be at least partially cancelled by the comparison without corresponding true quadrupole resonance signals being completely cancelled.

15. Apparatus for analysing a signal obtained by applying excitation to a sample and detecting a resonance response, comprising:
producing means for producing a model of the signal;
storing means for storing a predetermined model of a signal due to a phenomenon; and
comparing means for comparing the model to the predetermined model to determine whether the model represents a signal due to that phenomenon.

16. Apparatus according to claim 15 wherein the apparatus is adapted to produce models of the signal, and to compare the models to a predetermined model, until the model is determined to represent a signal due to the phenomenon or until a given number of repetitions have been completed.

17. Apparatus according to claim 15 wherein the apparatus is adapted to produce models of the signal, and to compare the models to a predetermined model, with models having increasing numbers of components.

18. Apparatus according to claim 15 being apparatus for testing a sample, further comprising means for applying excitation to the sample and means for detecting the response to yield the signal.

19. An apparatus for analysing a signal, to test a sample, the apparatus comprising:
detecting means for detecting a signal comprising a resonance response from the sample;
producing means for producing a model of the signal; and
comparing means for comparing the model to a predetermined model of a signal due to a phenomenon to determine whether the model represents a signal due to that phenomenon.

20. An apparatus according to claim 19, further comprising applying means for applying excitation to the sample to excite the resonance response.

21. Apparatus according to claim 19 wherein the apparatus is adapted to compare the model to a predetermined model of an undesired signal and to apply further excitation in dependence on the result of the comparison.

22. Apparatus according to claim 18 being a quadrupole resonance apparatus.

23. Apparatus for detecting the presence of a sample in a larger sample which is not known to contain the sample, comprising:
detecting means for detecting a signal comprising a response from the sample;
producing means for producing a model of the signal;
storing means for storing a predetermined model of a response from the sample; and
comparing means for comparing the model to the predetermined model to determine whether the sample is present.

24. Apparatus according to claim 23 further comprising means for providing an alarm signal if the sample is determined to be present.

25. Apparatus according to claim 15 being apparatus for nuclear quadrupole resonance testing a sample containing quadrupolar nuclei, which sample may give rise to spurious signals which interfere with response signals from the quadrupolar nuclei, comprising:
means for applying a pulse sequence to the sample to excite nuclear quadrupole resonance, the pulse sequence comprising at least one pair of pulses;
means for detecting response signals; and
means for comparing, for the or each such pair, the respective response signals following the two member pulses of the pair;
the pulse sequence being such that the respective spurious signals following the two member pulses can be at least partially cancelled by the comparing means without the corresponding true quadrupole resonance signals being completely cancelled.

26. A computer readable medium having stored thereon a program for carrying out the method of claim 1.
